(19) United States
(12) Patent Application Publication
(10) Pub. No.: US 2017/0106560 A1
(43) Pub. Date: Apr. 20, 2017

(54) FENCE ASSEMBLY FOR MITER SAW

(71) Applicant: REXON INDUSTRIAL CORP., LTD., Taichung (TW)

(72) Inventor: Chih-Chin HSU, Taichung (TW)

(21) Appl. No.: 15/293,345

(22) Filed: Oct. 14, 2016

(30) Foreign Application Priority Data
Oct. 15, 2015 (TW) 104133887

(51) Int. Cl. B27B 27/06; B23D 45/02

(52) U.S. Cl. CPC B27B 27/06; B23D 45/024

(57) ABSTRACT

A fence assembly for miter saw includes a mounting base mounted at a supporting base and defining a first abutting surface that extends perpendicular to a work surface of the supporting frame, a first fence member detachably mountable at the mounting base and defining a second abutting surface that is disposed perpendicular to the work surface of the worktable and co-planar with the first abutting surface of the mounting base, and a second fence member detachably mountable at the supporting base and defining a third abutting surface that is disposed perpendicular to the work surface in a non-coplanar manner relative to the first abutting surface of the mounting base. Thus, the user can selectively mount the first fence member or the second fence member to adjust the cutting stroke.

### BACKGROUND OF THE INVENTION

1. Field of the Invention

The present invention relates to miter saw technology and more particularly, to a fence assembly for use in a miter saw.

2. Description of the Related Art

When using a miter saw to cut a workpiece, the user will place the workpiece on the worktable to abut the workpiece against a fence, enabling the workpiece to be supported in position by the fence and avoiding displacement of the workpiece during the cutting operation.

In a conventional miter saw, the fence is affixed to the supporting base and not adjustable to change the position according to actual cutting requirements. Subject to the limitation of the position of the fence, the saw arm can simply be moved within a predetermined stroke, resulting in a limitation on the cutting stroke.

### SUMMARY OF THE INVENTION

The present invention has been accomplished under the circumstances in view. It is the main object of the present invention to provide a fence assembly for miter saw, which allows adjustment of the position according to actual cutting requirements, solving the problem of limited cutting stroke.

To achieve this and other objects of the present invention, a fence assembly comprises a mounting base, a first fence member and a second fence member. The mounting base is mounted at a supporting base, comprising a first abutting surface that extends perpendicular to a work surface of the supporting base. The first fence member is detachably mounted at the mounting base, comprising a second abutting surface. After installation of the first fence member in the mounting base, the second abutting surface is disposed perpendicular to the work surface of the supporting base and coplanar with the first abutting surface of the mounting base. The second fence member is detachably mountable at the supporting base, comprising a third abutting surface. The third abutting surface is disposed perpendicular to the work surface in a non-coplanar manner relative to the first abutting surface of the mounting base.

Thus, the user can selectively mount the first fence member or the second fence member. When the first fence member is installed, the first abutting surface of the mounting base and the second abutting surface of the first fence member hold the workpiece positively in position for cutting. At this time, the cutting stroke of the saw arm of the miter saw maintains its original cutting stroke. When the second fence member is installed, the third abutting surface of the second fence member supports the workpiece positively in position for cutting. At this time, the gap between the third abutting surface of the second fence member and the first abutting surface of the mounting base is used to increase the cutting stroke of the saw arm of the miter saw.

Other and further advantages and features of the present invention will be understood by reference to the following specification in conjunction with the accompanying drawings.

### BRIEF DESCRIPTION OF THE DRAWINGS

FIG. 1 is a perspective view of a miter saw equipped with a fence assembly in according to the present invention, illustrating a first fence member mounted on a mounting base.

FIG. 2 is a partially exploded view of the fence assembly in accordance with the present invention.

FIG. 3 is a schematic side view of the present invention, illustrating the relationship between the mounting base and the first fence member.

FIG. 4 is similar to FIG. 1, illustrating a second fence member mounted on the mounting base.

FIG. 5 is a schematic side view of the present invention, illustrating the relationship between the mounting base and the second fence member.

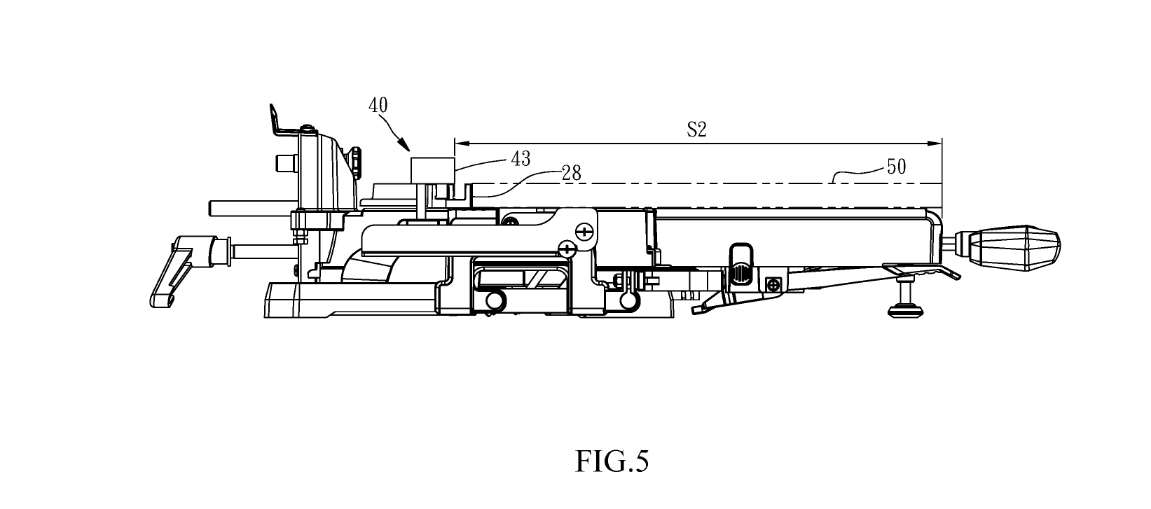

### DETAILED DESCRIPTION OF THE INVENTION

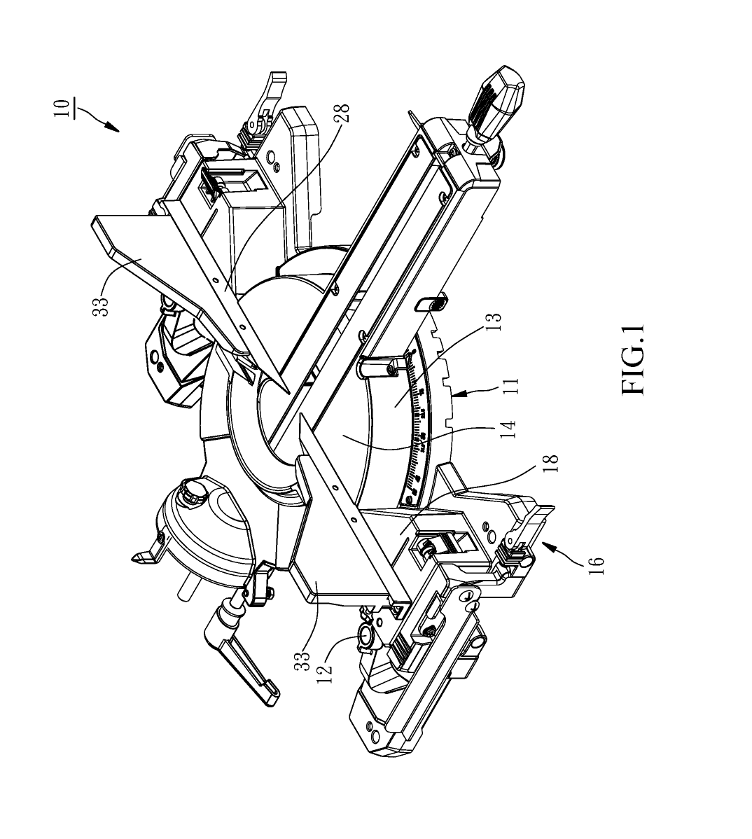

Referring to FIG. 1, a fence assembly 10 in accordance with the present invention is shown used in a miter saw that comprises a supporting base 11 and a worktable 13. The supporting base 11 comprises a first locating hole 12 located on each of two opposite ends thereof. The worktable 13 is mounted on the supporting base 16, defining a work surface 14 for holding a workpiece (not shown). Since the miter saw is the known machine tool and not within the scope of the present invention and in order to save space, the structural details and operating principle of the miter saw will not be described here.

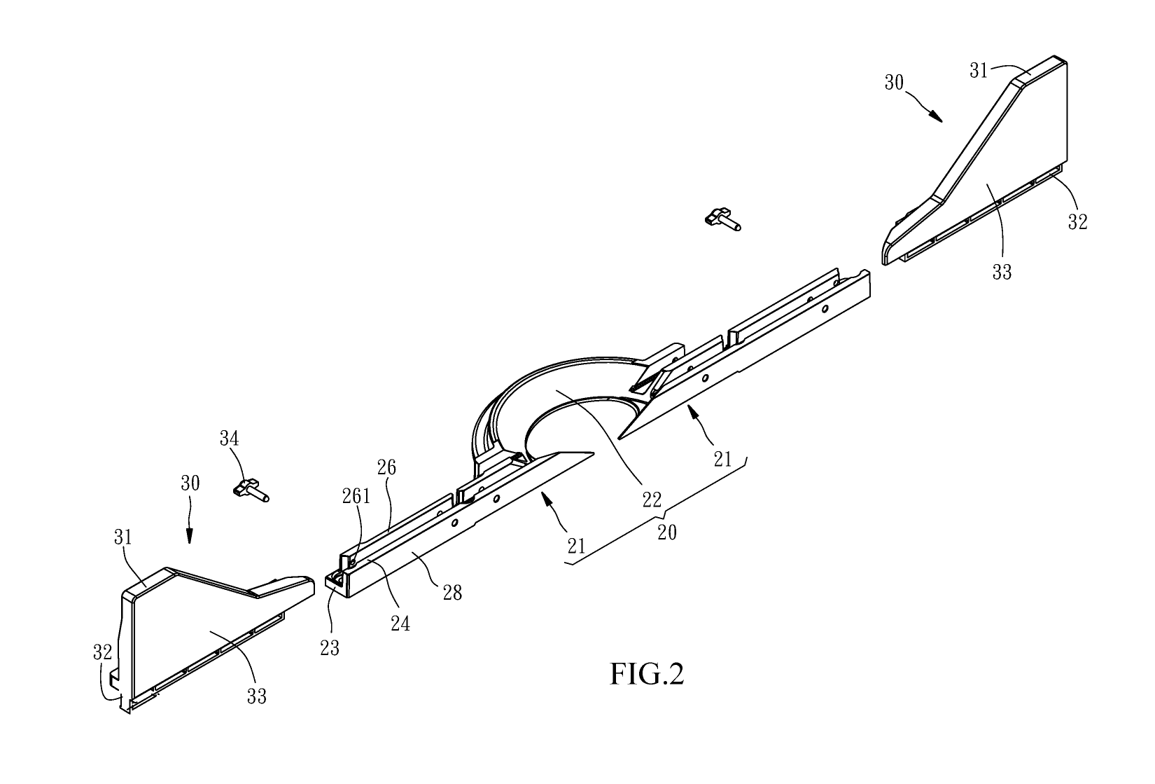

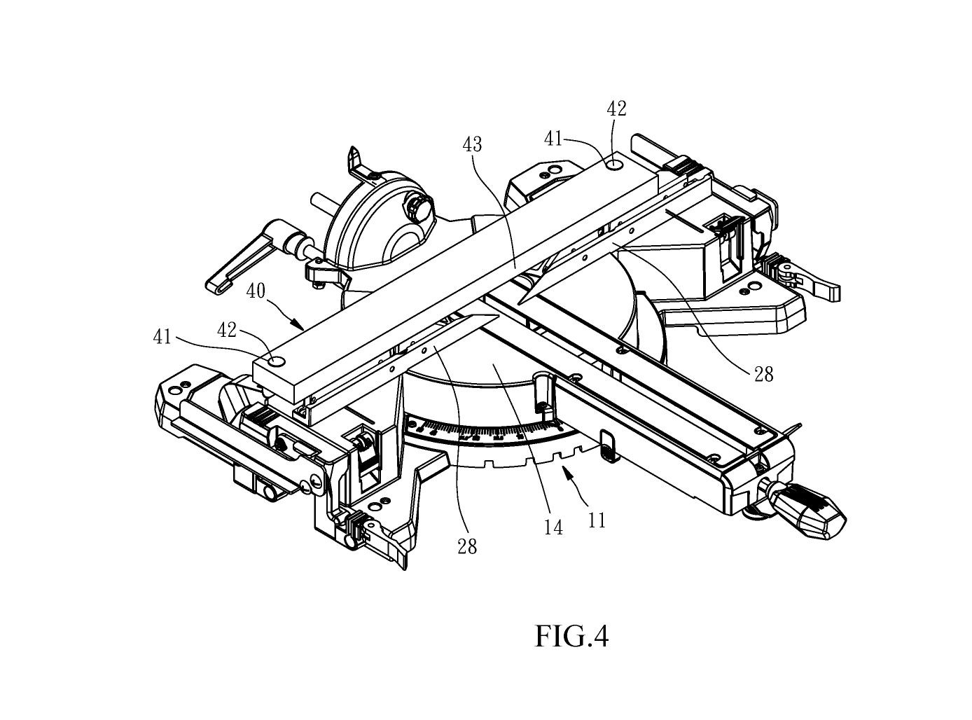

Referring to FIGS. 2 and 4, the fence assembly 10 comprises a mounting base 20, two first fence members 30, and a second fence member 40.

The mounting base 20 is affixed to the work surface 14 of the supporting base 11, comprising two mounting parts 21 and an arched connection part 22 connected between the two mounting parts 21. Each mounting par 21 defines a bottom wall 23, a first upright wall 24 and a second upright wall 26. The first upright wall 24 and the second upright wall 26 are respectively connected to a top surface of the bottom wall 23 such that a retaining groove 27 is defined by the bottom wall 23, the first upright wall 24 and the second upright wall 26. Further, the second upright wall 26 defines therein a screw hole 261.

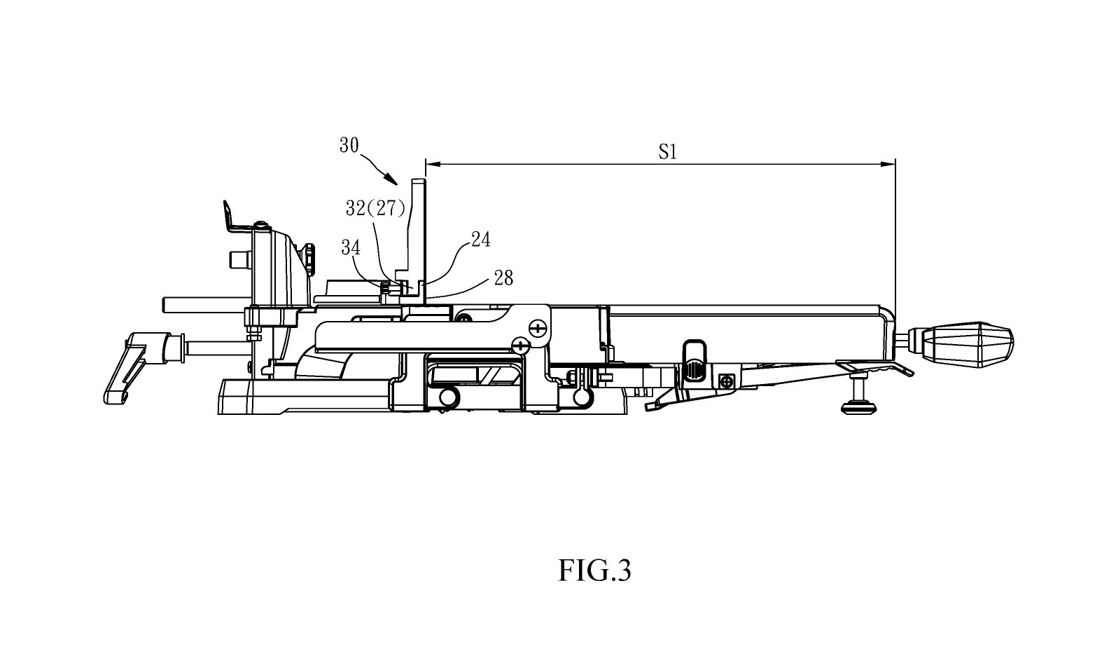

Each first fence member 30 comprises an abutment portion 31 and an engaging portion 32. The abutment portion 31 defines a second abutting surface 33. The engaging portion 32 is connected to a bottom surface of the abutment portion 31. When the engaging portion 32 is engaged into the retaining groove 27 of the mounting base 20, the second abutting surface 33 of the abutment portion 31 of the respective fence unit 30 is disposed coplanar with the first abutting surface 28 of the mounting base 20. Further, as illustrated in FIG. 2 and FIG. 3, after engagement of the engaging portion 32 of the fence unit 30 in the retaining groove 27 of the mounting base 20, a locking member 34 is installed to lock the first fence member 30 in position. The locking member 40 in this embodiment is a lock screw bolt threaded into the screw hole 261 of the second upright wall 26 of the mounting base 20 with the distal end thereof stopped against the engaging portion 32 of the respective first fence member 30, enabling the engaging portion 32 of the respective first fence member 30 to be forced by the second upright wall 26 of the mounting base 20 to abut against the first upright wall 24 of the mounting base 20.

As illustrated in FIG. 4, the second fence member 49 has a second locating hole 41 located at each of two opposite ends thereof. Two locating rod members 42 are respectively mounted in the respective first locating holes 12 of the supporting base 11 and the respective second locating holes 41 of the second fence member 40 to fasten the second fence member 40 to the supporting base 11.

Further, the second fence member 40 comprises a third abutting surface 43 that extends perpendicular to the work surface 14 of the worktable 12 in a non-coplanar manner relative to the first abutting surface 28 of the mounting base 20.

Thus, when the user mounts the first fence members 30 at the mounting base 20, the first abutting surface 28 of the mounting base 20 is disposed coplanar with the second abutting surfaces 33 of the first fence members 30, providing positive support to the workpiece. At this time, the saw arm maintains its original cutting stroke S1 (see FIG. 3). If the user wishes to increase the cutting stroke, remove the first fence members 30 from the mounting base 20, and then mount the second fence member 40 at the supporting base 11. After installation of the second fence member 40 in the supporting base 11, a gap is left between the third abutting surface 43 of the second fence member 40 and the first abutting surface 28 of the mounting base 20. The presence of this gap causes the cutting stroke of the saw arm to be changed from S1 to S2 (see FIG. 4). Further, in order to prevent the non-coplanar relationship between the first abutting surface 28 of the mounting base 20 and the third abutting surface 43 of the second fence member 40 from affecting the positioning stability of the workpiece to be cut after the installation of the second fence member 40, the user can place a raiser block 50 on the worktable 12 and then place the workpiece on the raiser block 50, enabling the workpiece to be mainly supported by the third abutting surface 43 of the second fence member 40 in position. Further, the height of the raiser block 50 is larger than or equal to the height of the first abutting surface 28 of the mounting base 20.

In conclusion, the fence assembly 10 of the present invention allows the user to selectively install the first fence members 30 or the second fence member 40 so that the cutting stroke of the saw arm can be relatively adjusted, and thus, the design of the present invention solves of the problem of limited cutting stroke of the prior art technique.

What is claimed is:

1. A fence assembly used in a miter saw comprising a supporting base and a worktable rotatably supported on said supporting base, said supporting base defining a work surface, the fence assembly comprising:
a mounting base mounted at said supporting base, said mounting base comprising a first abutment surface perpendicular to said work surface of said supporting base;
at least one first fence member detachably mountable at said mounting base, each said first fence member comprising a second abutting surface, said second abutting surface being disposed perpendicular to said work surface of said worktable and coplanar with said first abutting surface of said mounting base; and
a second fence member detachably mountable at said supporting base, said second fence member comprising a third abutting surface disposed perpendicular to said work surface of said worktable in a non-coplanar manner relative to said first abutting surface of said mounting base.

2. The fence assembly as claimed in claim 1, wherein said mounting base comprises at least one retaining groove; each said first fence member further comprises an engaging portion adapted for engaging into one respective said retaining groove.

3. The fence assembly as claimed in claim 1, wherein said mounting base further comprises at least one screw hole, and a locking member fastenable to one respective said screw hole and stoppable against the said engaging portion of one respective said first fence member to lock the said engaging portion of the respective said first fence member to the respective said retaining groove of said mounting base.

4. The fence assembly as claimed in claim 1, wherein said supporting base comprises a first locating hole located at each of two opposite ends thereof; said second fence member comprises a second locating hole located at each of two opposite ends thereof and respectively fastened to the respective said first locating holes of said supporting base by a respective locating rod member.

5. The fence assembly as claimed in claim 1, further comprising a raiser block, said raiser block having a height larger than or equal to the height of said first abutting surface of said mounting base, said raiser block being placed on said work surface of said worktable and abutted against said first abutting surface of said mounting base after installation of said second fence member in said supporting base.
